(19) United States
(12) Patent Application Publication
(10) Pub. No.: US 2024/0367096 A1
(43) Pub. Date: Nov. 7, 2024

(54) Carbon Sequestering Exhaust Filtration System

(71) Applicant: Brock Tyler Horstman, Salem, OH (US)

(72) Inventor: Brock Tyler Horstman, Salem, OH (US)

(21) Appl. No.: 18/310,067

(22) Filed: May 1, 2023

(51) Int. Cl. B01D 53/26

(52) U.S. Cl. CPC B01D 53/266; B01D 2257/50

(57) ABSTRACT

A Carbon Sequestering Exhaust Filtration System that utilizes air conditioning to accelerate the cooling of Hydrogen atoms from exhaust fumes to more quickly pass through said pipe's inner lining to drip off the porous outer encasement which facilitates air flow for heat dispersion from the internal pipe. Said pipe then attaches to an exhaust fume filtration port which contains replaceable, biodegradable Carbon particulate filtering bags for an environmentally sustainable exhaust fume filtering attachment that expels purified air outside.

### BACKGROUND

### Technical Field

The present invention relates to exhaust systems and biomass filtration.

### Prior Art

The following is a tabulation of some prior art that presently appears relevant:

### Non-Patent Literature Documents

Yamada, T. (2020) This natural air purifier uses a miniature forest to rapidly clean your atmosphere!—yanko design, Yanko Design—Modern Industrial Design News. Available at: https://www.yankodesign.com/2020/09/25/this-natural-air-purifier-uses-a-miniature-forest-to-rapidly-clean-your-atmosphere-2/ (Accessed: Feb. 2, 2023).
Torbet, G. (2021) Proposed CO2 capture system could reduce truck emissions by 90 percent, Engadget. Available at: https://www.engadget.com/2019-12-23-epfl-truck-carbon-dioxide-capture-system.html#:˜:text=The%20carbon%20dioxide%20capture%20works%20by%20first%20cooling,dioxide%20from%20other%20gases%20like%20nitrogen%20and%20oxygen. (Accessed: Feb. 1, 2023).

### BACKGROUND

Exhaust Pipe Systems have existed as long as automotive cars have existed, yet in the last 100-plus years, the exhaust system as a whole has only once been significantly improved. In 1954, the patent for the catalytic converter was approved and since then no widespread changes have come to improve the exhaust pipe system in a way that either conveniently or efficiently remove more of the greenhouse gases from exhaust terminals before they emit the fumes into the atmosphere.

In Sweden, an automotive exhaust purifying system has been developed. This technology features water-condensing air cooling technology which extracts the water from the emissions; however, this system still employs a large tank to capture carbon in a sink on top of each car roof. This is not only inefficient, but also inconvenient and impractical for the busy average citizen to make good use of.

In terms of air purification capability, the problem with manufactured electrostatic air cleaning materials like HEPA (High Efficiency Particulate Air) filters is that the design and material of a HEPA filter is not dense enough to capture the significant amounts (pounds per day of driving) of potential Carbon Dioxide in a way that can usefully sequester the carbon in a medium which can also be quickly replaceable as well as biodegradable-something electrostatic air cleaning material like a HEPA filter cannot serve as.

### SUMMARY

In accordance with one embodiment, a Hydrogen filtering exhaust pipe system molded and encased within a porous composite that connects to a pipe that delivers dried exhaust fumes to an exhaust fume filtration port that holds within it a replaceable, biodegradable Carbon particle filtration bag that collects Carbon from exhaust fumes before the remaining purified air is expelled. This system is made more effective by adding attachments for air conditioning to supply the system with an additional cooling mechanism. The separated Hydrogen cools and passes through the pipe's Hydrogen-permeable lining to the porous outer composite where it collects and drips away. The remaining dried fumes within the system then pass through a Carbon bed in the form of a replaceable, biodegradable Carbon filter bag inside the Carbon filtration port. These filter bags contain biomass for Carbon filtration where said Carbon is deposited.

### Advantages

Accordingly, some notable advantages exist with the use of said Carbon Sequestering Exhaust Filtration System. The ability to filter a significantly higher amount of Carbon from exhaust fumes before they get expelled into the environment is an advancement via the combined technologies employed in said system. The combined technologies include, but are not limited to: a porous composite exhaust pipe attachment for Hydrogen removal, the A/C attachment within said Hydrogen filtering system that accelerates the exhaust fume cooling process, the Hydrogen permeable pipe lining ushering Hydrogen particles outside, and the porous composite exhaust pipe encasement that allows air to passively flow through it and disperse heat while expelling Hydrogen from the system. The biodegradable filtering bags have at least two advantages. The main advantage is that said system is both a convenient and effective way for users to filter the Carbon out of the fumes they combust. Also, said filter bags are part of a sustainable system by being completely biodegradable.

Said system facilitates the filtering of a significant amount of Carbon fumes from an exhaust system without requiring a water tank to do so. Said system is a convenient way to sequester Carbon and prevent it from being expelled into outside air.

### DRAWINGS—FIGURES

FIG. 1 shows the collective Carbon Sequestering Exhaust Filtration System.

FIG. 2 shows how a Carbon filtration bag port can open to extract a used biodegradable Carbon filter bag with subsequent bag optionally being planted directly into the ground where a seed can be nourished by its contents as it decomposes.

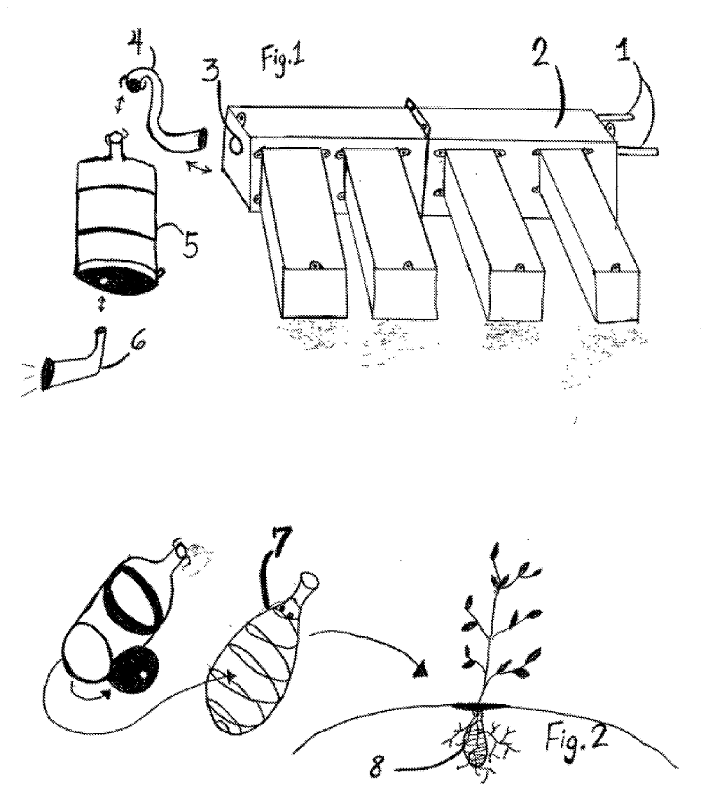

### DRAWINGS—REFERENCE NUMERALS

1. Air Conditioning Attachment
2. Porous Exhaust Pipe Encasement
3. Hydrogen Permeable Pipe Lining
4. Connecting Pipe
5. Filter Port
6. Terminal Exhaust Pipe
7. Biodegradable Carbon Filter Bag
8. Decomposing Carbon Filter Bag Nourishing Seedling

### DETAILED DESCRIPTION

Said Carbon Sequestering Exhaust Filtration System is essentially composed of two parts. The first part of said system is a pipe network in a porous composite encasement with said pipe lined with a material that allows Hydrogen atoms to pass through it, but not larger particles like Carbon. These materials are marked by their function and not by their composition, there are potentially numerous composite materials that can be used. The second part of the Carbon Sequestering Exhaust Filtration System is the Carbon filtration port where Carbon is filtered out of fumes in a filter bag which is replaced when filled. The first part of the system removes Hydrogen from exhaust fumes and the second part removes and stores Carbon in a biodegradable filter bag. The Carbon Filtration Port that holds the bags connects by pipe to the Hydrogen Filtering System which allows dried fumes to flow through the filtration bag port and thereby also going through the exhaust fume filter bag for Carbon to be deposited in. With a filtration bag in the filtration bag port, the fumes pass through and are purified of Carbon and then pass through a terminal pipe which expels purified air outside. Carbon particulate matter is deposited in Carbon filtration bags and accumulates until being filled up and disposed of, optionally being planted with an indigenous seed inside it. The first part of the system can vary widely in form as a result of said composite's moldable shape of which said Hydrogen filtering pipes are encased within, and can be shaped to serve additionally as a vehicle's rear tailgate or hatchback door, or as a molded surface attachment affixed to the top, back, and/or undercarriage of a vehicle.

### CONCLUSION, RAMIFICATIONS, AND SCOPE

Thus the reader will see that any embodiment of said Carbon Sequestering Exhaust Filtration System creates a new exhaust system that filters exhaust fumes without losing engine power. Said Carbon Sequestering Exhaust Filtration System additionally creates a way to directly sequester the Carbon filtered particulate matter back into nature via deposition within biodegradable filter bags which can then be planted as tree seed pods.

While the above description contains many potential applications for usage, these should not be construed as a limitation on the scope, but rather as an exemplification of one of several of its embodiments. Many other variations are possible; for example, the Carbon Sequestering Exhaust Filtration System can be used as an additive filtering component for large industrial building's air purifying systems for a more beneficial environmental impact.

Accordingly, the scope of the disclosure should be determined not by the embodiment(s) illustrated, but by the appended claims and their legal equivalents.

1. A Carbon Sequestering Exhaust Filtration System that consists of the following:

2. A porous composite exhaust pipe encasement featuring Air Conditioning attachments and a Hydrogen-permeable pipe lining that delivers dried air to the second part of said system:

3. A Carbon Sequestering Exhaust Fume Filtration Port that holds within it replaceable and biodegradable Carbon particulate filtering bags that purify exhaust fumes of Carbon particulate matter.
